(19) United States
(12) Patent Application Publication
(10) Pub. No.: US 2011/0169631 A1
(43) Pub. Date: Jul. 14, 2011

(54) REAL-TIME ALARM SYSTEM

(76) Inventors: Ming-Hwa SHEU, Yunlin County (TW); Ching-Long Chang, Yulin County (TW); Wen-Kai Tsai, Yunlin County (TW); Hsin-Chang Yeh, Yunlin County (TW); Huan-Yao Kang, Yulin County (TW); Yu-Shian Lin, Yunlin County (TW)

(21) Appl. No.: 12/685,248

(22) Filed: Jan. 11, 2010

(51) Int. Cl. G08B 1/08

(52) U.S. Cl. 340/539.11; 340/539.1; 340/539.25

(57) ABSTRACT

A real-time alarm system comprises an image capturing element, a network transmission system, a control processing unit and a mobile device. The image capturing element is installed on different sites to generate image information. The image information is transmitted through the network transmission system with one end linking to the image capturing element. The control processing unit is linked to the network transmission system and includes a server, and contains preset information to compare with the image information to generate comparison information. The comparison information is analyzed by a preset algorithm to judge behaviors of objects in the images. The mobile device is linked to the control processing unit to receive the image information. After the control processing unit judges specific behaviors, it actively informs the mobile device to record a video for a selected duration to be seen anytime at a remote site.

### FIELD OF THE INVENTION

The present invention relates to a surveillance system and particularly to an intelligent real-time alarm system.

### BACKGROUND OF THE INVENTION

In recent years, reports of unsafe events and hazardous incidents on newspapers and TV news increase at an alarming rate. They often take place randomly and could happen on resident areas or working places and recreation sites in different types and unpredictable ways. This causes a great stress to people. The awareness of self and family protection grows significantly. People's life and work quality also are impacted.

Refer to FIG. 1 for a conventional surveillance system. It comprises a monitor 1 and a computer 2 to perform monitor operation. The monitor 1 installed on public places, aside from monitoring different places at the same time, also provides alarm function to protect public safety. The conventional surveillance system usually requires a lot of manpower to do image judgment. Its cost is very high. Moreover, it also needs human judgment and coordination before making real-time alarm, hence response timing still leaves a lots to be desired. In terms of instant judgment and notification, there are still rooms for improvement.

### SUMMARY OF THE INVENTION

In view of the disadvantages of the conventional technique, the present invention aims to provide a real-time alarm system that offers an improved technique to enhance community safety and reduce costs.

The real-time alarm system according to the present invention comprises at least one image capturing element, at least one network transmission system, a control processing unit and at least one mobile device. The image capturing element is installed on a selected site to record and generate continuous image information. The network transmission system has one end linking the image capturing element to transmit the image information. The control processing unit is linked to the network transmission system and contains at least one preset information to compare with the image information and perform process to generate a comparison information. The mobile device is linked to the control processing unit to receive the comparison information.

The real-time alarm system thus formed provides many benefits, notably:

1. The network transmission system provides instant transmission of the image information and comparison information. The control processing unit can perform monitor by comparing and checking the preset information with graphic information and time information at different sites that require verification. A great of manpower can be saved and response time is shortened. It greatly improves public safety.

2. In addition to public safety, with growing popularity of communication products such as cellular phones, portable computers or PDAs, people at present also demand more personal and residential privacy. Hence striking a proper balance between safety and privacy becomes a growing requirement of the surveillance system that is not achievable in the conventional surveillance system located on public place. The present invention provides the mobile device and control processing unit to perform a desired service and monitor to meet such a requirement.

3. The conventional surveillance system often records a great amount of useless images and results in waste of storage space, and also makes browsing historical images difficult. The control processing unit of the present invention can analyze specific conditions and record the images sent from the image capturing element for a selected duration to reduce image storage space and research time during browsing the historical images.

The foregoing, as well as additional objects, features and advantages of the invention will be more readily apparent from the following detailed description, which proceeds with reference to the accompanying embodiment and drawings. The embodiment serves merely for illustrative purpose and is not the limitation of the invention.

### BRIEF DESCRIPTION OF THE DRAWINGS

FIG. 1 is a schematic architecture of a conventional technique.

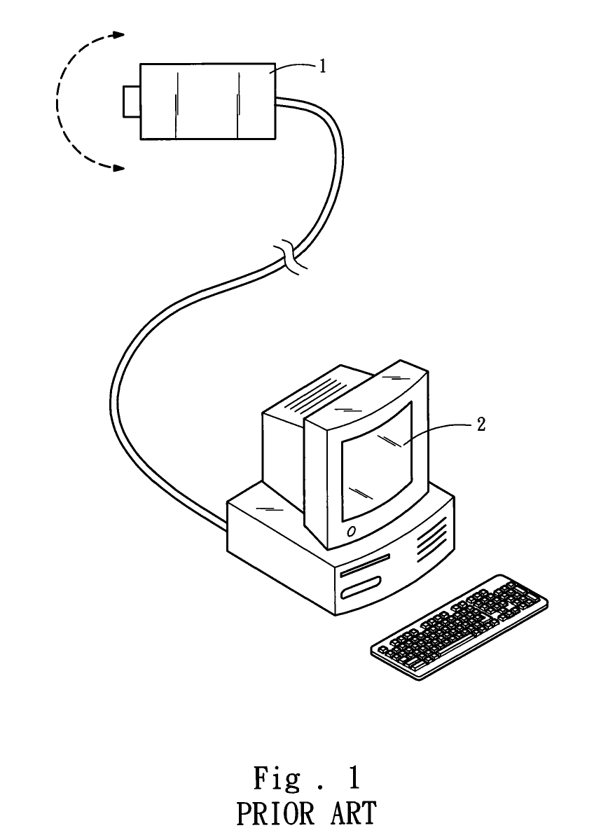

FIG. 2 is a schematic architecture of the present invention.

FIG. 3 is a flow chart of the present invention when in use.

### DETAILED DESCRIPTION OF THE PREFERRED EMBODIMENT

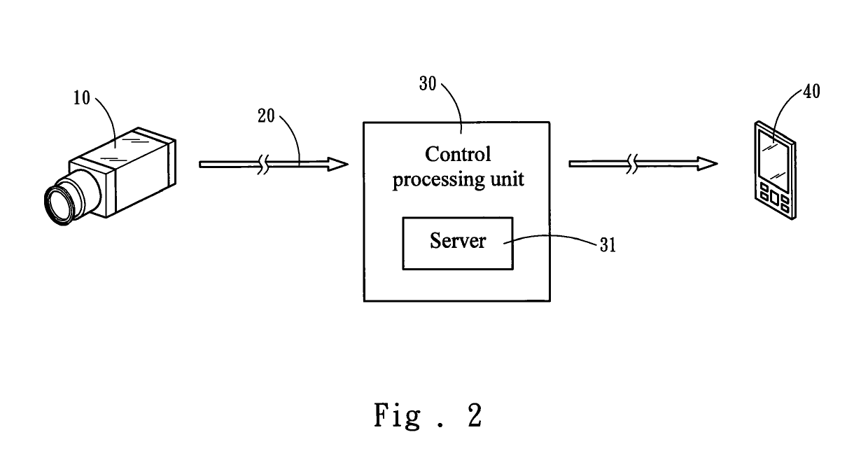

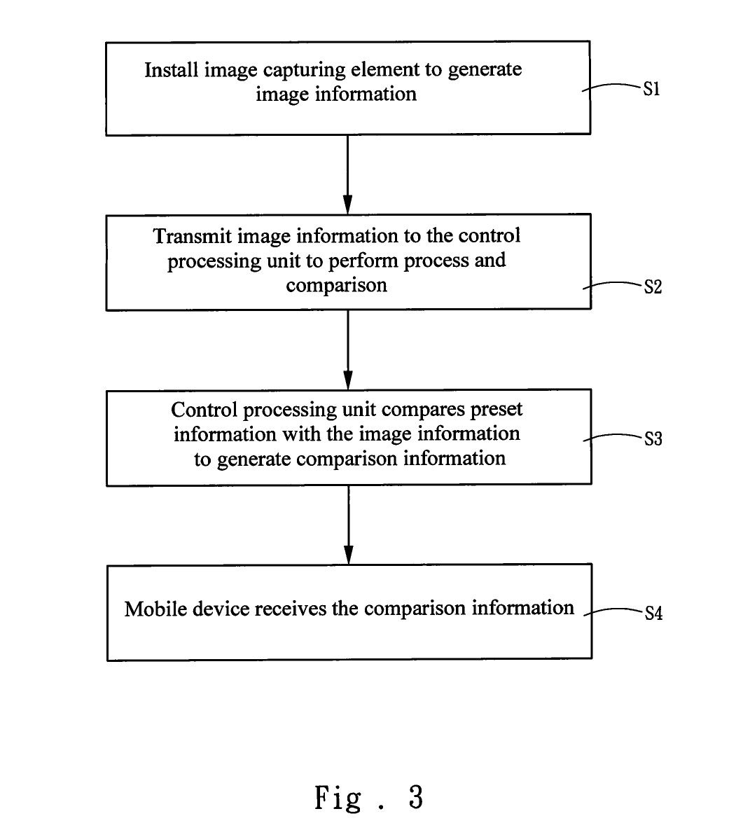

Please refer to FIGS. 2 and 3, the real-time alarm system according to the present invention comprises at least one image capturing element 10, at least one network transmission system 20, a control processing unit 30 and at least one mobile device 40. The image capturing element 10 is installed on a selected site to record and generate continuous image information. The image capturing element 10 can be a video camera or a monitor. The network transmission system 20 has one end linking the image capturing element 10 to transmit the image information. The control processing unit 30 is linked to the network transmission system 20. The network transmission system 20 may be an IP-based network, such as wireless local area network (WLAN), Ethernet, 3G network or WiMAX. The control processing unit 30 contains at least one preset information to compare with the image information and perform process to generate a comparison information. The mobile device 40 is linked to the control processing unit 30 to receive the comparison information.

The control processing unit 30 also includes a server 31 which contains a Session Initiation Protocol (SIP). The control processing unit 30 and mobile device 40 are linked through an IP-based network. The mobile device 40 may be a telephone, a personal computer, a notebook computer, a cellular phone, or a PDA.

Refer to FIG. 3 for the procedures of the present invention. It comprises steps S1 through S4. Step S1: Install the image capturing element 10 on a selected site to generate image information. Step S2: Transmit the image information to the control processing unit 30 to perform process and comparison; the image information generated by the image capturing element 10 at the selected site is sent through the network transmission system 20 to the control processing unit 30 for processing. Step S3: The control processing unit 30 compares the received image information with the preset information to generate the comparison information. Step S4: The mobile device 40 receives the comparison information transmitted from the control processing unit 30.

As a conclusion, the present invention can provide instant transmission of the image information and comparison information. The control processing unit 30 can compare the preset information with graphic information and time information at varying sites that are required to be compared and checked, and perform monitor. Such an approach not only can save a great deal of manpower that otherwise needed in the conventional technique, the response time can be shortened, and demand of human labor can be reduced to spare the manpower to do other desired businesses. This also helps to improve public safety.

In addition, aside from taking into account of public safety, with growing popularity of communication products such as cellular phones, portable computers and PDAs, people at present also demand more personal and residential privacy and take close care of family members. Hence striking a proper balance between safety and privacy becomes a growing requirement of the surveillance system that is not achievable in the conventional surveillance system located on public place. The control processing unit 30 of the present invention contains the preset information which can be adjusted and altered according to user's requirements of different sites and conditions, such as personal privacy, family members, or varying public sites such as tunnels, museums, natural disaster image monitor and the like. Through connection between the mobile device 40 and the control processing unit 30, instant transmission and fast alert services can be accomplished to meet users' requirements. It helps to improve public safety.

What is claimed is:

1. A real-time alarm system, comprising:
at least one image capturing element installed on a selected site to capture and record to generate at least one image information;
at least one network transmission system which includes one end linking to the image capturing element to transmit the image information;
a control processing unit which is linked to the network transmission system and contains at least one preset information to process and compare with the image information to generate a comparison information; and
at least one mobile device linking to the control processing unit to receive the comparison information.

2. The real-time alarm system of claim 1, wherein the image capturing element is selected from the group consisting of a video camera and a monitor.

3. The real-time alarm system of claim 1, wherein the network transmission system is an IP-based network selected from the group consisting of a wireless local area network, an Ethernet, a 3G network and WiMAX.

4. The real-time alarm system of claim 1, wherein the control processing unit includes a server which contains a session initiation protocol (SIP).

5. The real-time alarm system of claim 1, wherein the mobile device is selected from the group consisting of a telephone, a personal computer, a notebook computer, a PDA and a cellular phone.

6. The real-time alarm system of claim 1, wherein the control processing unit and the mobile device are linked through an IP-based network, such as wireless local area network, an Ethernet, a 3G network or WiMAX.
